(19) United States
(12) Patent Application Publication
(10) Pub. No.: US 2013/0332319 A1
(43) Pub. Date: Dec. 12, 2013

(54) System and method for purchased enabled profiles

(71) Applicant: Thomas Zuber, Los Angeles, CA (US)

(72) Inventor: Thomas Zuber, Los Angeles, CA (US)

(21) Appl. No.: 13/899,501

(22) Filed: May 21, 2013

Related U.S. Application Data
(63) Continuation-in-part of application No. 12/885,325, filed on Sep. 17, 2010, now Pat. No. 8,464,162.
Application No. 12/885,325 is a continuation-in-part of application No. 13/278,127, filed on Oct. 20, 2011.
Application No. 13/278,127 is a continuation of application No. 13/011,655, filed on Jan. 21, 2011, now abandoned.
Application No. 13/011,655 is a continuation-in-part of application No. 13/023,461, filed on Feb. 8, 2011.
Application No. 13/023,461 is a continuation-in-part of application No. 13/645,234, filed on Oct. 4, 2012.
Application No. 13/645,234 is a continuation-in-part of application No. 13/849,418, filed on Mar. 22, 2013.
Application No. 13/849,418 is a continuation-in-part of application No. 13/892,183, filed on May 10, 2013.
(60) Provisional application No. 61/688,835, filed on May 21, 2012.
(60) Provisional application No. 61/455,985, filed on Oct. 29, 2010.
(60) Provisional application No. 61/629,949, filed on Nov. 30, 2011.
(60) Provisional application No. 61/685,747, filed on Mar. 22, 2012.
(60) Provisional application No. 61/688,335, filed on May 10, 2012.

(51) Int. Cl. G06Q 30/06

(52) U.S. Cl. CPC G06Q 30/0601
USPC 705/27.1

(57) ABSTRACT

The invention provides system and method whereby members of an online community are able to fund their online community member profile accounts, and are able to make purchases using those funds, or credit, which are in or associated with an online community member profile account.

### CROSS REFERENCE TO RELATED APPLICATIONS

This application claims the benefit of U.S. Provisional Application Ser. No. 61/688,835 filed May 21, 2012, which is hereby incorporated by reference in its entirety.

This application is related to commonly-owned U.S. Application Ser. No. 61/210,627, filed Mar. 20, 2009, U.S. application Ser. No. 12/493,096, filed Jun. 26, 2009, U.S. application Ser. No. 12/575,442, filed Oct. 7, 2009, U.S. application Ser. No. 12/885,325, filed Sep. 17, 2010, U.S. application Ser. No. 13/011,655, filed Jan. 21, 2011, U.S. application Ser. No. 13/023,461, filed Feb. 8, 2011, U.S. application Ser. No. 13/247,813, filed Sep. 28, 2011, U.S. application Ser. No. 13/278,127, filed Oct. 20, 2011, U.S. application Ser. No. 13/324,980, filed Dec. 13, 2011, U.S. application Ser. No. 13/645,234, filed Oct. 4, 2012, U.S. application Ser. No. 13/849,418, filed Mar. 22, 2013. and U.S. application Ser. No. 13/892,183, filed May 10, 2013. The contents of each of these patent applications are incorporated herein in their entirety by reference, each of which is incorporated by reference herein in its entirety.

### BRIEF HISTORY OF THE INVENTION

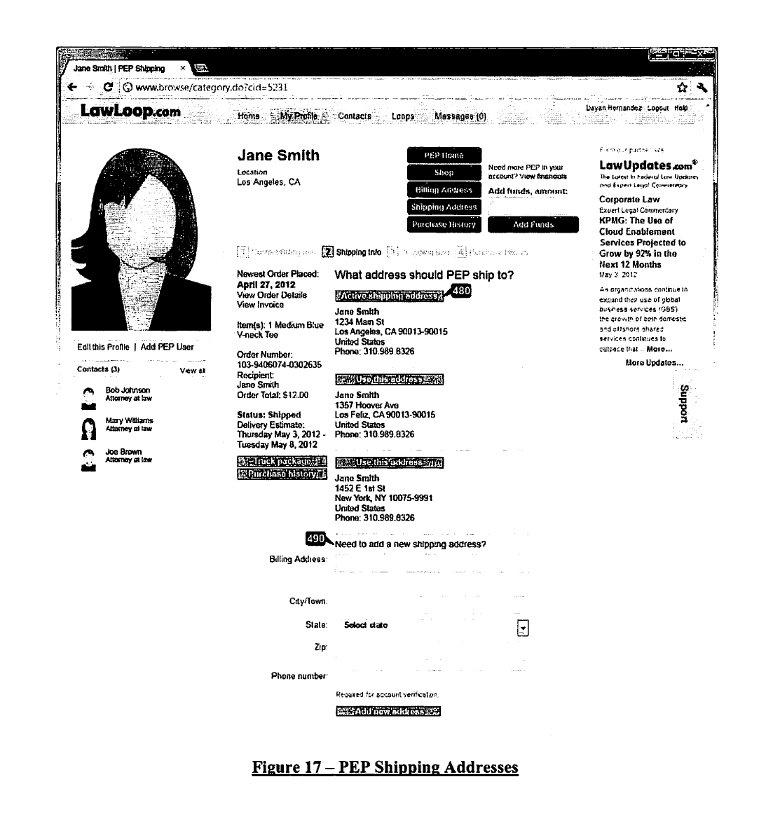

Currently how a person shops online could be considered to be rather tedious. A person shopping online, or user, must search to locate an item of interest, click through several screens, or complete several steps, and fill out various forms, such as billing and shipping information forms, with each individual online vendor in order to successfully complete a purchase transaction. To begin with a user logs on to the internet, opens an internet browser and must decide whether to use a search engine to attempt to locate an item of interest that they would like to purchase, or a savvier user may navigate directly to a vendor's online store by directly entering the vendor's URL in the browser, that may likely have the item available for purchase. However even when the user arrives at the vendor's online store, the user must search further still in order to arrive at a page that only has items similar to the item that is being sought. For example if the user is looking for a blue V-neck t-shirt the user must search for it with a search engine or go directly to a vendor's online store that is likely to carry that item. After successfully reaching a vendor's online store the user must locate the item of interest and decide whether or not to proceed with the purchase. Typically a user is given the option to either begin the purchase transaction directly from a page where general search results appear or they may have to click through to an item's dedicated details page. For example once the user arrives at the vendor's online store, it is unlikely that the user's item of interest will be featured on the homepage. If this is not the case the user must begin a search within the vendor's online store to narrow results. If the user is a clothing vendor's online store the user may click on the shirts category and then proceed to narrow the results by applying more filters to the search results, such as brand and fit type, or simply by refining their initial search terms. Eventually, if the vendor does indeed have the item in inventory, the user may arrive at a page with V-neck t-shirts of various styles, colors and price points. Some online vendors allow for the purchase transaction to begin at this stage and provide a “Buy” link or button on or near the item in question. Other online vendors require that the user click on the item or item description to go to a dedicated page of the item where a “Buy” link or button is available. If the user decides to proceed with the purchase at this point and if the item is a one size fits all item then all the user must do is decide what quantity to purchase. If not, as is the case with an item such as the blue V-neck t-shirt, the user must decide on several details before placing their order. Not only must the user decide on quantity but also size and typically other things like “Is this a gift?” so that it may be packaged differently. Once the user has decided that they only want one medium blue V-neck t-shirt, if the user isn't already signed-in to the vendor's online store, they must register. An online vendor typically requires that the user supply basic details about themselves, such as their name, a form of payment, such as a credit card, an email address for notices and a shipping address. Once all of that has been successfully with the vendor the user must still click-through various screens in order to confirm their order. Sometimes they are the same screen but it isn't uncommon to have the user confirm what shipping address they would like to have their order shipped to, especially if the user has multiple shipping addresses on file (as shown at 480 in FIG. 17). The user may add a new shipping address at any time (as shown at 490 in FIG. 17). Finally the user arrives at an order confirmation screen that lists all of the purchase order details. This is the final opportunity for the user to edit their purchase order details before clicking a “Place Order” button or link to finalize and submit their order. If the user must edit a detail then the user must return to a previous screen before making their way back to the purchase order confirmation screen. After the user clicks the “Place Order” button or link the purchase transaction is finally completed. If the user has sufficient credit or funds with which to pay the vendor and the vendor accepts the purchase order transaction the user is notified of the successful transaction either by email or text and is given tracking information with which to track their order. Hopefully the item is to the user's liking because if it isn't then the item must be returned and that's a different process in and of itself.

### How Purchases are Made In-Store Currently

The shopper may passively or actively enter a physical store location that may carry an item of interest in its inventory which the shopper may be seeking for purchase. In either case the user must take the time to identify the item of interest on a shelf, rack or in-store display in order to begin the purchase process. That is if the shopper wishes to proceed with the purchase at all. Once the shopper identifies the item in-store and decides to follow through with its purchase the shopper must decide what quantity to purchase. If it's a one size fits all type of item then the shopper just has to decide what quantity to purchase. If not, as would be the case with a blue V-neck t-shirt, the shopper would have to try on t-shirts of various sizes and perhaps different shades of blue. If they don't already know their size the shopper may want to be certain that the fit is adequate or may simply want to see how the item looks and feels while being worn. Typically it's a good idea to try on clothing in-store as vendors are known to size their inventory by different scales or by what's commonly known as vanity sizing. This means having to find the fitting rooms and probably waiting in line to get into one in order to try on the item. If the item is to the shopper's liking the shopper may proceed to the checkout to pay for the item(s). After having located a checkout counter the shopper may again have to wait in line. Once the shopper has made their way to the checkout clerk the shopper must wait again in order for the clerk to process the item(s) being purchased and the method of payment in order to successfully complete the purchase transaction. If the item being purchased has been tagged with any sort of sensor, typically a type of electronic article surveillance (hereinafter referred to as EAS) system like a Radio Frequency Identification tag (hereinafter called RFID), the clerk must disable the tag before finalizing the purchase transaction. Finally, the checkout clerk bags the purchased item(s) and the purchase transaction is successfully completed. The shopper is now free to leave the in-store premises as the owner of their newly purchased item(s) and a receipt.

### DETAILED DESCRIPTION OF “PURCHASE ENABLED PROFILES” INVENTION

A person or user makes use of a Purchase Enabled Profile (hereinafter referred to as “PEP”) in order to facilitate the shopping experience and to track purchases for re-order. A PEP is intended to make the shopping experience more convenient for shoppers by enabling their social networking member profiles to make purchases in the real and online worlds on their behalf. A social networking member profile is an online representation of the user who uses their profile to network and socialize with other members in a network, like a Facebook user profile or a LawLoop.com member profile. A PEP user in the real world need only scan an item's machine readable code and confirm its purchase in order to complete the entire purchase transaction. A PEP user in the online world need only click on an item and confirm its purchase in order to complete the entire purchase transaction and in the process have the item shipped to their designated address. In both the real and online shopping experiences the shopper, or user, never has to register a form of payment with the vendor in order to successfully complete a purchase transaction. Instead payment is made via their PEP and in the case of the online shopping experience their shipping information is also communicated to the vendor at the point of purchase. In all, the shopping experience is streamlined with PEP as the user doesn't have to look for a form of payment in their wallet or purse while waiting in a line in the real world. Meanwhile online the whole shopping experience is reduced to only a few clicks, without having to fill out various forms. To add another layer of convenience, should the user wish to re-order an item they may do so directly from their PEP shopping history.

### Opening a PEP Account

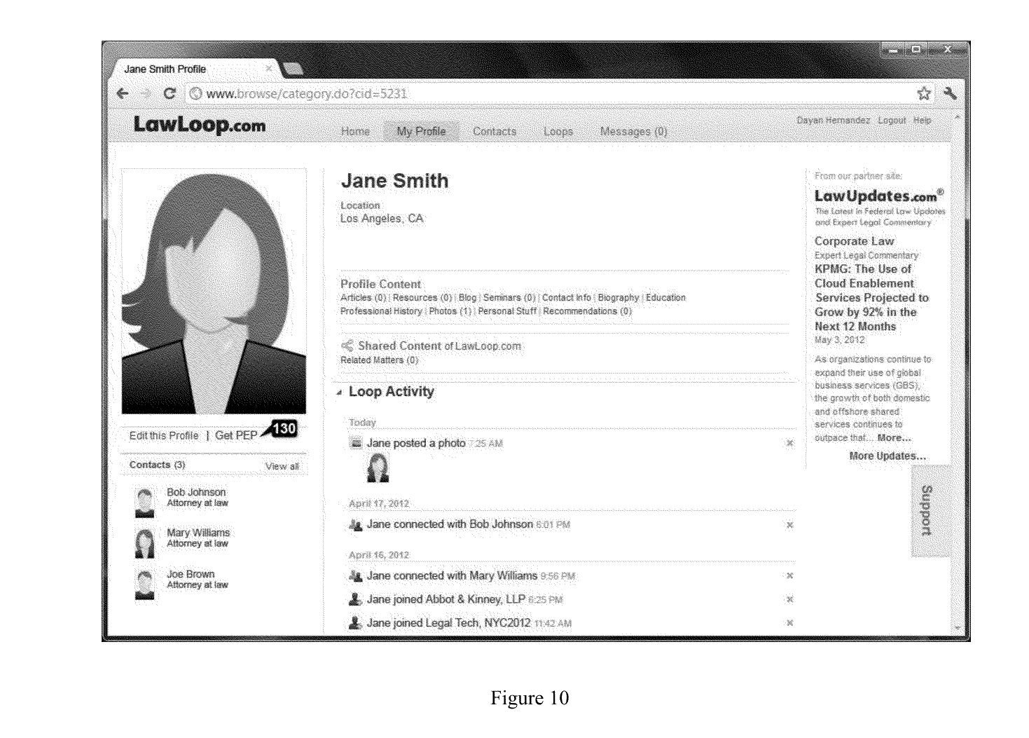

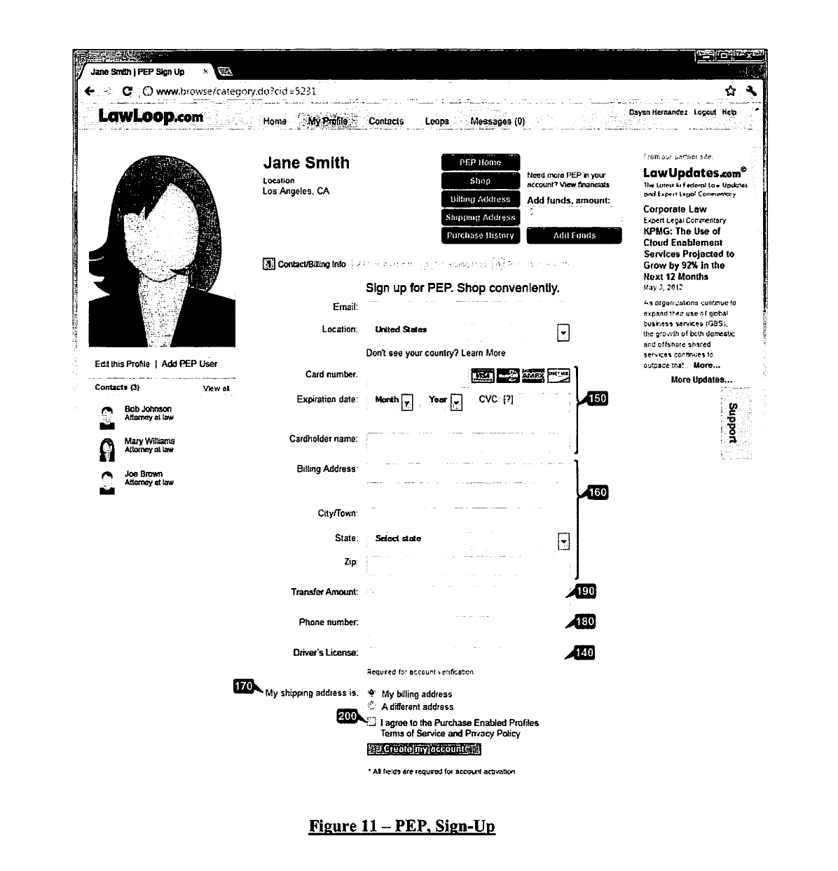

The user first creates a social networking member profile and chooses to enable that profile to make purchases (as shown at 130 in FIG. 10). In order to successfully activate their PEP account the user needs to enter their personal information in a form and verify their identity by using a fingerprint, driver's license, passport, etc. (as shown at 140 in FIG. 10). The user must provide information for one credit card (as shown at 150 in FIG. 10). The user must provide addresses for billing (as shown at 160 in FIG. 10) and shipping (as shown at 170 in FIG. 10). The user may connect their profile to a handheld device (as shown at 180 in FIG. 10). The handheld device could be a cell phone or a device specifically designed for making purchases. The user can immediately enter a sum of money or credit that they would like to transfer into their PEP account (as shown at 190 in FIG. 10). After completing all the required information and the user agrees to PEP's terms and conditions (as shown at 200 in FIG. 10) the user submits their information, and if everything has been filled out correctly and accurately the user's PEP account is created. The credit that the user designated to have transferred into their PEP account is immediately available to the user.

Alternative embodiment: The user can choose which credit source to provide when signing up to open their account, be it credit card, ATM debit card, checking account or savings account. Also, since the user is signing up to enable their profile to make purchases via their profile, some fields that the user must fill out may already be know when the user initiates the sign-up process. This being the case, certain fields such as the card holder's name or address may be prefilled for the user's convenience.

### PEP Funds and Credit

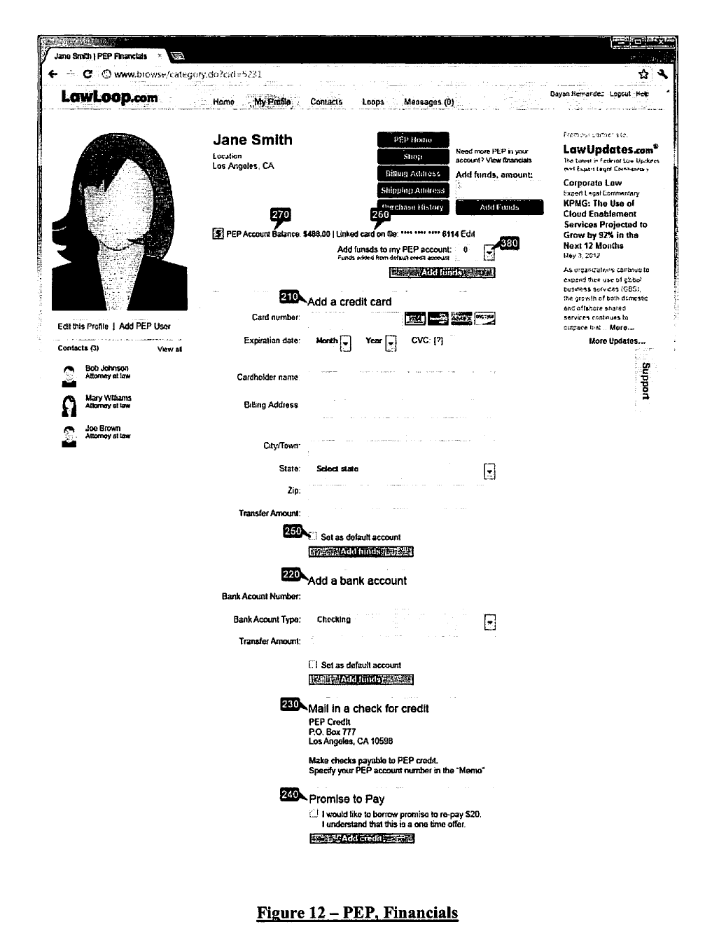

When a user's profile has been established the user may add credit to their account by using an ATM debit card or credit card (as shown at 210 in FIG. 12), writing and mailing in a check (as shown at 230 in FIG. 12), or by bank transfer (as shown at 220 in FIG. 12). For example, in the preferred embodiment, the funds that PEP uses for purchases are drawn from either a credit account or bank account. One of these accounts, which the user has registered with PEP, is designated as the user's PEP default credit account (as shown at 250 in FIG. 12). Initially the user's default credit account will be the credit card account they registered when signing up for their PEP account but the user may enter other sources of credit and designate any one of them to be their default credit account. The user may choose to designate their preferred default credit account only if the user has multiple sources of credit registered in their PEP account. The user may incur debt on their profile with a “promise to pay” instead of adding credits to the account initially (as shown at 240 in FIG. 12). The promise to pay may serve as an introductory or promotional feature to PEP where the sum that is to be repaid by the user can vary. In this debt scenario the user does not apply credits to the account using a credit card or check, but incurs debt against the profile with a “promise to pay.” Alternative embodiment: The user may link a source of money or credit, be it a credit card, ATM debit card, checking or savings bank account to their PEP account (as shown at 260 in FIG. 12). In this manner the user will not have to periodically transfer more credit into their PEP account. Instead the user will always have credit available via PEP equal to whatever funds are available in the user's linked source of credit, (if it's designated as the user's default credit account). In other words the user can have available funds, credit or money that they have already deposited into their PEP account (as shown at 270 in FIG. 12), and available credit which would be a liked source of money or credit (as shown at 260 in FIG. 12). It is the user's discretion as which account is set as the default account, to be used as the primary account from which funds are drawn.

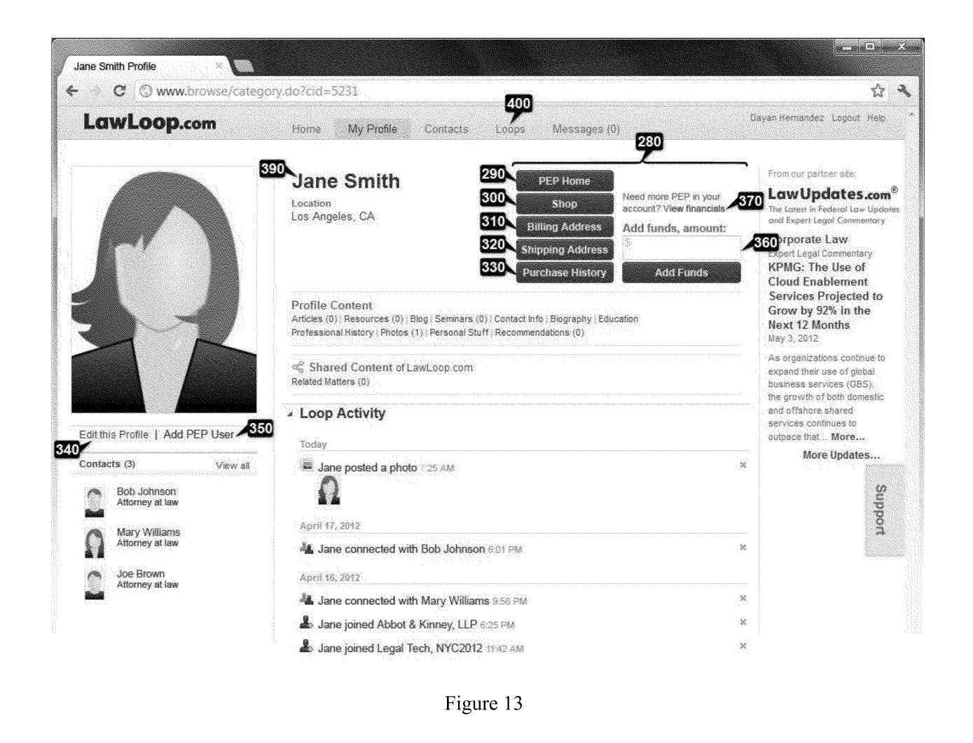

For example, once the user has an activated PEP the user will have PEP navigation appear on the profile page they chose to enable to make purchases on their behalf (as shown at 280 in FIG. 13). These navigation buttons link the user to various aspects of their PEP profile. The user may choose to begin shopping immediately. If they want to see all the available online shopping catalogs the user would likely click on the Shop button (as shown at 300 in FIG. 13). The user may also choose to edit their billing address (as shown at 310 in FIG. 13), shipping address or addresses (as shown at 320 in FIG. 13), view their purchase history (as shown at 330 in FIG. 13), edit their profile (as shown at 340 in FIG. 13), add authorized users (as shown at 350 in FIG. 13), and can add funds to their PEP account (as shown at 360 in FIG. 13). The user can click the View financials link (as shown at 370 in FIG. 13) to view details regarding their credit such as their PEP account balance (as shown at 270 in FIG. 12). While at the PEP Financials page, the user may transfer a pre-determined sum of funds into their PEP account profile (as shown at 380 in FIG. 12). The pre-determined funds are drawn from the user's default money or credit account. The pre-determined funds drop down feature is present primarily for the user's convenience as it involves less typing. In the preferred embodiment, only the owner of the PEP profile can view the “Add funds” field (as shown at 360 in FIG. 13) and View financials link (as shown at 370 in FIG. 13). Any and all credit information, such as account balances, bank account information and billing addresses may only be disclosed to the PEP profile verified owner (as shown at 390 in FIG. 13). When attempting to access sensitive financial data such, for example when clicking on the View financials link, the user will be prompted with a pop-up, overlay or intermediary page that requires the user to re-enter their username and password in order to confirm their identity. Since the user is already logged in to the PEP account, the user's username will already be pre-entered in the appropriate field, only requiring that the user re-enter their PEP account password to verify their identity. Once the account has been verified and has credit available the user is immediately ready to make purchases online or in-store. Alternative embodiment: The user who is the owner of the PEP account, which is the user that opened the verified PEP account, may authorize additional individual users or even other social networking network profiles to access and use their PEP account on their behalf. For example the PEP account owner could grant invited users and profiles full management rights to their PEP account, which would allow the invited user or profile full access and rights to all areas and facets of the PEP owner's account. The PEP owner may also grant some degree of partial management rights. For example, the invited user or profile could be able to make purchases using the PEP owner's account and designate shipping addresses but would not be allowed to initiate a transfer of funds from the PEP owner's default credit account and would be barred from certain areas of the PEP owner's account, like their PEP Financials page.

Shopping with a PEP

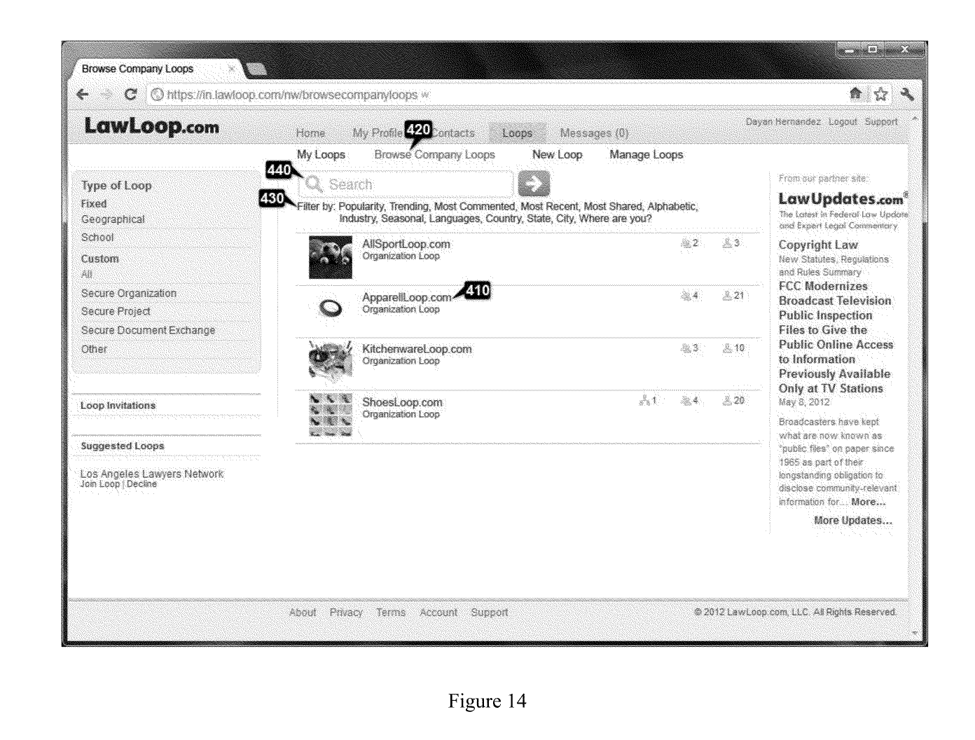

The PEP profile owner is ready to make purchases online or in-store. In order to make a purchase online, the user visits the product or company's social network profile and clicks a link to view their online catalog. From the user's profile page the user can reach a company's social network profile in two ways. The most direct method is for the user to click on Shop in their PEP navigation (as shown at 300 in FIG. 13). The user may also click on the Loops link (as shown at 400 in FIG. 13). Loops are a type of network. Once the user has clicked on the Loops tab the user may click Browse Company Loops (as shown at 420 in FIG. 14). This will show the user a full listing of all the companies that have a social network profile. The user may search directly for a company or vendor by name (as shown at 440 in FIG. 14) or passively via filters (as shown at 430 in FIG. 14). If the user does search for a vendor by name then the user is free to add filters to their search. For example if the user simply enters a search term of “V-neck T” there may be a lot of retail Loops listed and the user may want to know which one is the most popular one. In this case the user would click on the Popularity and/or Trending filter(s). It depends entirely on what the user is looking for. The Popularity filter takes into account all the instances of the social network profile in which it was shared, commented on, the amount of traffic/visits it gets, the number of members it has, and perhaps even how many Likes it has. In short the Popularity filter list in order the company social network profiles that have the highest and best stats in every category that is tracked. The Trending filter on the other hand is not as encompassing as it deals with more immediate statistics, such as “What is getting the most traffic/visits right now?” and “What is being commented on and shared the most right now?” This is the case because a trending social network profile may not necessarily be the most popular overall, but maybe the vendor is having an incredible sale and the user base is buzzing and acting out about it. If this is the case the Trending filter would reveal this. There are a number of other filters that are more straightforward such as the Most Commented, Most Recent, Most Shared, Alphabetic, Industry, Seasonal, Country, State and City. The Languages and “Where are you?” filters may not be quite as straightforward. The Languages filter would include search results that are in other languages. In this case the user would be prompted with a pop-up, interstitial or overlay that lists all of the various languages from which the user could draw additional search results. In the case of the “Where are you?” filter, if clicked on the user would be prompted with a pop-up, interstitial or overlay where the user could enter their location. The search results would then have a distance variable associated with them. From these results the user could then organize their search by proximity to the user's point of origin. Some filters also have multiple states. For example, if the user clicks on the Popularity filter once, then search results are organized from most popular to least popular. The search result that is listed first at the top of the first page of results is then the most popular. However, if the user clicks on the Popularity search filter then the order reverses, meaning that search results are listed from least popular to most popular. The least popular result would then be listed at the top of the first page of results. If the filter is clicked yet again then the filter is turned off. While any filter may be turned on and off, not all filters may reverse the order of their results. Filters that have the functionality to reverse their search results' order are the Popularity, Trending, Most Commented, Most Recent, Most Shared, and the Alphabetic filter. The user may employ any combination of search filters that they wish to try.

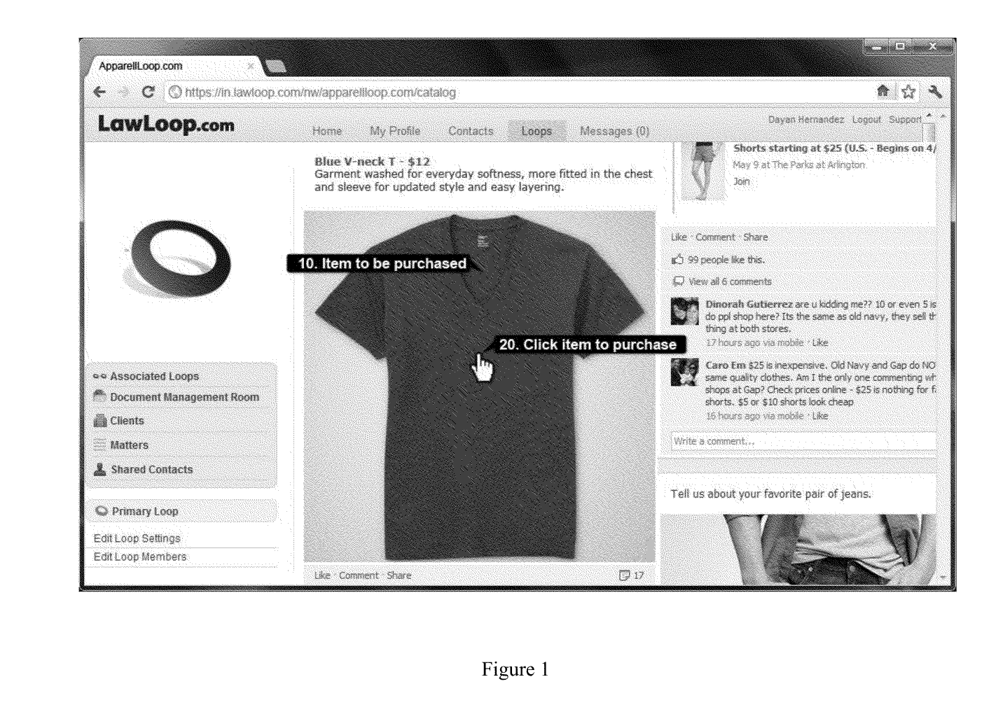

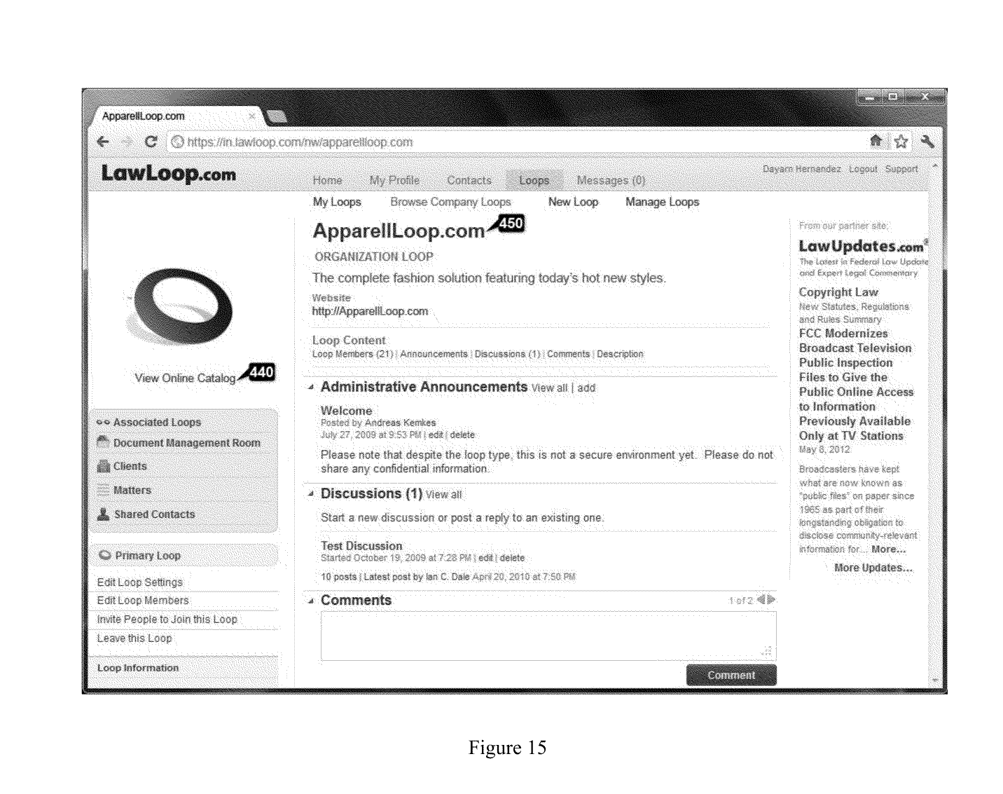

Once the user has found a vendor of interest and clicked on the company's loop (as shown at 410 in FIG. 14) then the user arrives at that company's social network profile (as shown at 450 in FIG. 15). From the company's profile the user can click to view their online catalog (as shown at 440 in FIG. 15). Online catalogs list products available for purchase and their price in plain text, with photos or a combination of both in order to communicate inventory availability and details (as shown at 10 in FIG. 1). Shopping with a PEP can be as easy as identifying an item for purchase in an online catalog, clicking on the item, deciding a few purchase order details, (such as quantity, size and color, if applicable) and confirming the purchase. By confirming, the purchase funds are drawn from the user's PEP profile account to pay for the item immediately and simultaneously the item is shipped to the user designated shipping address. No billing information need be entered at the online catalog point of purchase, or any shipping address information. The entire purchase transaction is handled via the user's PEP account profile. The user can also walk into a physical store location, identify an item they'd like to purchase, scan the item's UPC barcode or RFID code, confirm the purchase and immediately walk out of the store with the item bought and paid for. Alternative embodiment: The user can add multiple items into a shopping cart, and to only click “buy” once, when the user is ready to check-out. PEP would still track each item individually, but in this case there would only be one purchase transaction for all the items in the user's shopping cart instead of one for every item in the cart.

### Online Purchasing

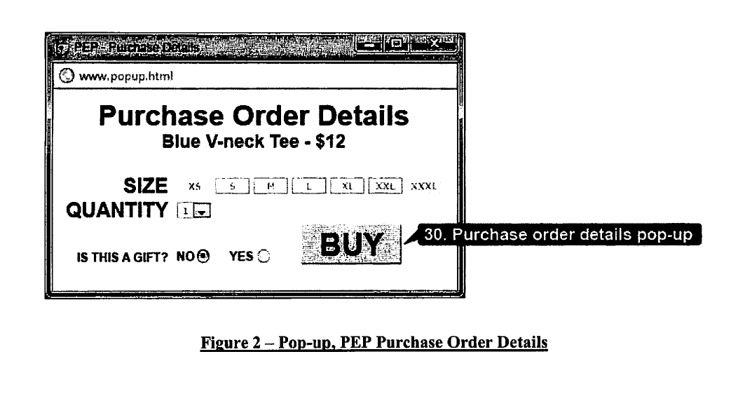

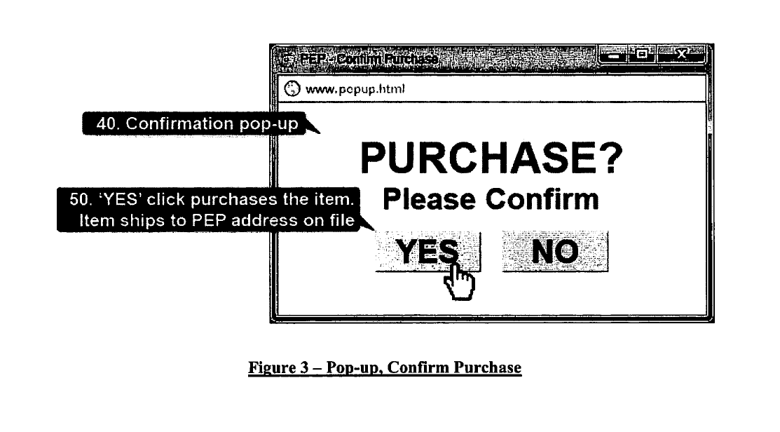

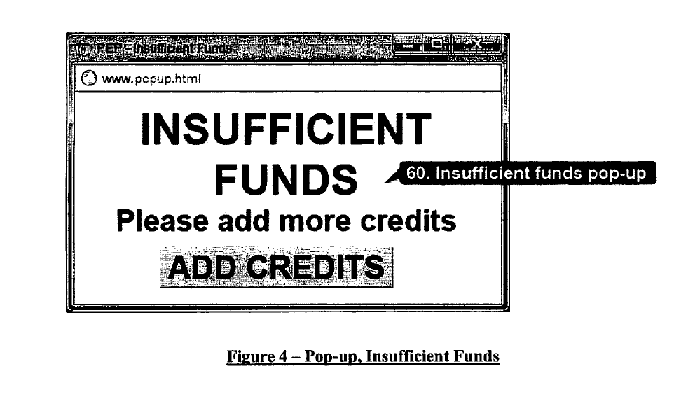

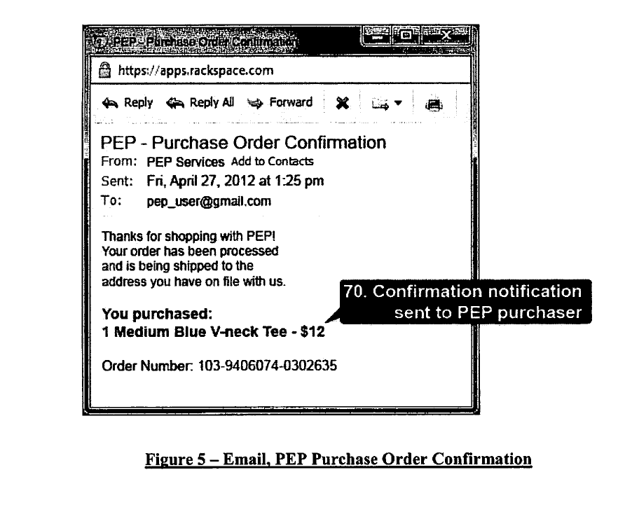

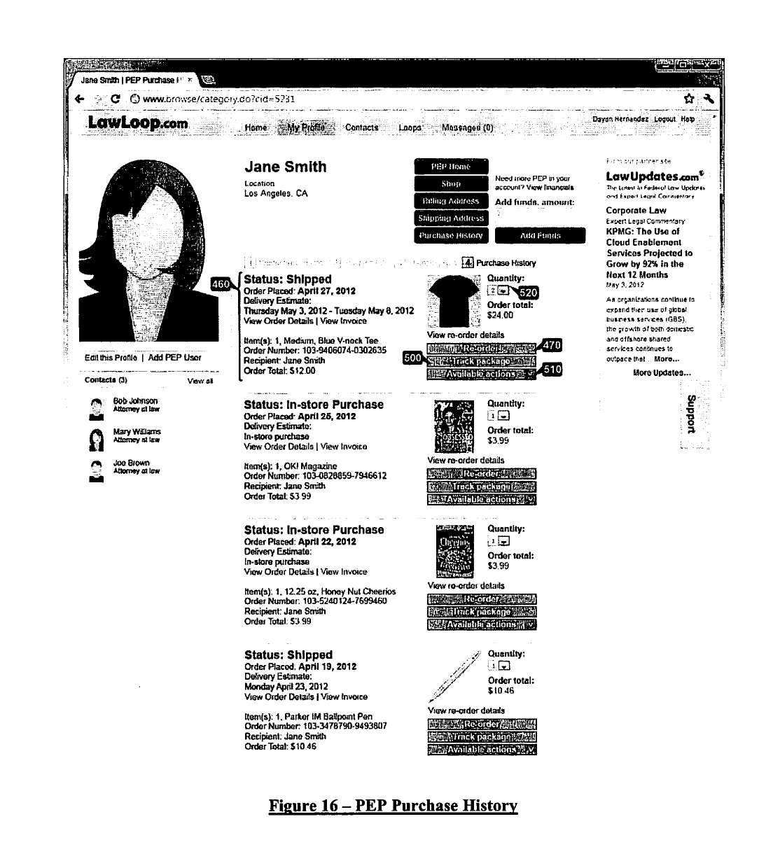

A user goes to a company's online network profile where they would find the company's online catalog (as shown at 10 in FIG. 1). The user selects an item that they would like to purchase, by clicking on the item, in this example a Blue V-neck T (as shown at 20 in FIG. 1). If there are purchase order details that must be decided, as is the case with the Blue V-neck T, the user is prompted with a pop-up that allows the user to determine what size shirt they would like, what quantity and whether the item is a gift or not. When the user has determined all of the purchase order details and clicks the “Buy” button (as shown at 30 in FIG. 2) the user is prompted with a purchase order confirmation pop-up (as shown at 40 in FIG. 3). If the user confirms the purchase by clicking on the affirmative “Yes” button (as shown at 50 in FIG. 3) and if the user has sufficient credit in their PEP account balance then the purchase transaction is completed successfully, the item is paid for, and it ships to the shipping address the user designated in their PEP profile. Upon clicking “Yes,” an amount corresponding to the purchase price of the item (plus shipping charges as applicable, handling charges as applicable, tax as applicable, and other charges as applicable) is automatically subtracted from the balance of the account or credit associated with the profile, and the item is registered as purchased. A sufficient PEP account balance means that the user has a more funds in their PEP account than the cost of the transaction they are trying to complete or has “promised to pay” a sum greater than the cost of the item. If the user clicks the “No” button on the confirmation pop-up (as shown at 40 in FIG. 13) the purchase is declined and the user returns to the catalog they were viewing with no purchase transaction having been made. If the user wishes to confirm the purchase transaction by clicking the “Yes” button but there is insufficient credit in their PEP account, the user receives a warning notification that eliminates the ability to overdraft their account (as shown at 60 in FIG. 4). For example, if the user has a $500 PEP account balance and the Blue V-neck T is $12, when the user clicks on the “Yes” button the purchase transaction is completed, their account immediately reflects the new $488 credit balance. The user now has $488 in credit with which to make additional purchases. After the user completes a successful purchase transaction a purchase order confirmation is emailed to the user (as shown at 70 in FIG. 5). The confirmation email is also the user's purchase order receipt. The confirmation email lists a description of the item and an order number that is a link to the order's full details in the user's PEP Purchase history (as shown at 460 in FIG. 16). The user's purchase is posted to their PEP purchase history immediately after the purchase order is confirmed. As soon as the order is shipped the user may track their package (as shown at 500 in FIG. 16). The Available actions drop-down menu (as shown at 510 in FIG. 16) is especially important to the user as it can do quite a few things such as be a starting point from where to track a package, return items, leave packaging feedback, write a product review, contact seller, file a claim, return items, leave seller feedback and write a product review. In the preferred embodiment the user may retrieve purchase order receipts of items previously purchased with their PEP via their purchase history's track package function. Alternative embodiment: The user may choose from any combination of delivery methods available in the marketplace by which to receive PEP notifications. For example, the user may opt to receive all of their purchase order confirmation notices sent to their handheld device via email, or text message regardless of what medium the user shops in, online or in-store. The user could also opt to set up their account to receive notifications for all online purchases sent to their email address and notifications of all their in-store purchases texted to their hand held device, or vice versa. This gives the user the flexibility to decide which notification delivery method(s) is the most convenient for the user.

### In-Store Purchasing

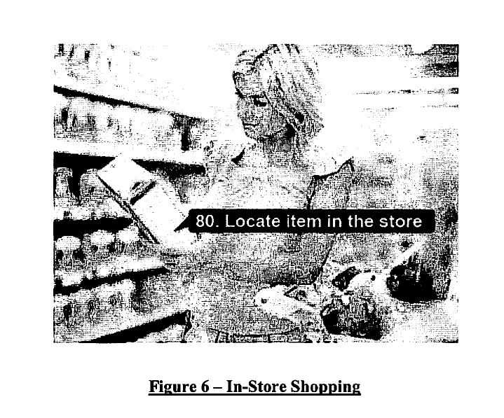

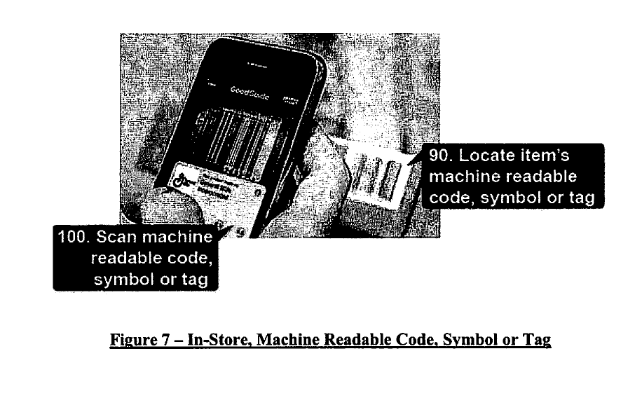

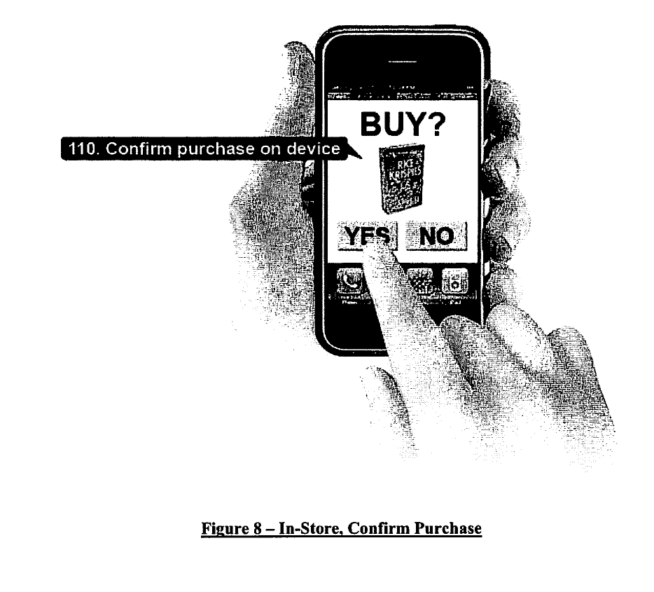

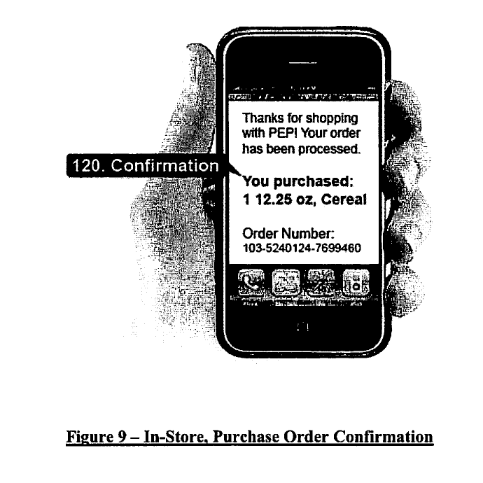

The shopper enters a store location and finds the desired item on a display shelf (as shown at 80 in FIG. 6). The shopper locates the machine readable code, symbol or tag on the item (as shown at 90 in FIG. 7), such as an RFID tag and/or UPC barcode and/or QR code. An item may have a machine readable code, symbol, tag or a combination thereof which can be scanned with a portable handheld device. The user scans the machine readable code or symbol using a handheld device that can connect with the user's PEP account profile to draw funds (as shown at 100 in FIG. 7). The user confirms the purchase on their handheld device by clicking the affirmative “Yes” button (as shown at 110 in FIG. 8). Upon clicking the “Yes” button, an amount corresponding to the purchase price of the item (plus shipping charges as applicable, handling charges as applicable, tax as applicable, and other charges as applicable) is automatically subtracted from the balance of the account or credit associated with the profile, and the item (and its corresponding barcode, QR code, RFID code, and/or other code) is registered as purchased. Again, if the user does not have sufficient funds in their PEP account they will receive a warning notification that eliminates the ability to overdraft their account. Instead of overdrafting their account they are asked to add more funds to their account. The purchase transaction is completed, drawing funds from the user's PEP account. The user receives a purchase order confirmation sent to their handheld device (as shown at 120 in FIG. 9). The purchase order confirmation also serves as the user' receipt as it cites a brief description of the item and an order number link that takes the user to their PEP purchase history where all the order's details are listed. As the purchase transaction has been successfully completed the item is free to leave the store premises immediately without triggering sensors or alarms. The transaction is immediately recorded in the user's PEP purchase history (as shown at 460 in FIG. 16). If the user clicks the “No” button on the confirmation screen (as shown at 110 in FIG. 8) the purchase is declined and the user returns to the “ready to scan item” screen (as shown at 100 in FIG. 7) that they were viewing with no purchase transaction having been made, ready to scan another item for purchase.

PEP works with In-Store Security

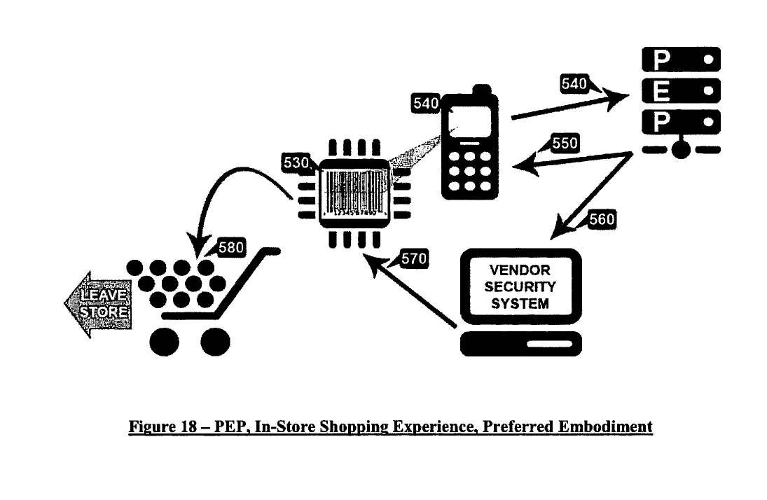

After a shopper has received a purchase order confirmation notification from their PEP account they rightfully expect to be able to leave the in-store premises without triggering any security sensors, alarms or be otherwise detained and/or arrested as they have successfully exchanged funds for their purchased item(s) of interest. In the preferred embodiment a machine readable code, symbol or tag that is unique to an item and can be scanned by a handheld device (as shown at 530 in FIG. 18), like a cell phone with a camera (as shown at 540 in FIG. 18), or another type of portable device would initiate the process of deactivating the item's security device, tag and/or system. When an item is scanned and the item's information is successfully communicated to the user's PEP account (as shown at 540 in FIG. 18) PEP will check the user's account to make sure that there are sufficient funds. If so the user will purchase the item by transferring funds for payment from the user's PEP account to the vendor (as shown at 560 in FIG. 18), the store's inventory management/tracking system acknowledges payment for the item whose code, symbol, or tag was scanned (as shown at 530 in FIG. 18) and re-categorizes the item from their inventory category to the sold category. Simultaneously, PEP sends the user a purchase order confirmation, to confirm that the item has been successfully purchased (as shown at 550 in FIG. 18). The confirmation notification serves as the user's receipt of purchase. When a scanned item is registered as a sold by the store's inventory management/tracking system the item's security device, tag and/or system is targeted by the store and immediately deactivated (as shown at 570 in FIG. 18). The item's security device, tag and/or system may be deactivated by the store's inventory management/tracking system itself or by a configuration of security system or systems. As the purchase transaction and the deactivation process of the item's security device, tag and/or system have both been successful the item is free to leave the store premises immediately without triggering any security sensors or alarms (as shown at 580 in FIG. 18). In the future, one EAS type may serve all basic necessary functions which are to identify the item individually to both PEP and vendors via its machine readable code or symbol, as well as to serve as the sensor that is disabled remotely after being purchased successfully. In today's marketplace when an item is physically purchased in-store the item's EAS system must be disabled at the point of purchase in order to keep sensors or alarms from being triggered when the item leaves the store premises. Failure to deactivate any EAS system typically results in sensors being triggered as the shopper walks through the pedestal or tower gates, one of which is a transmitter and the other a receiver, that are found at the store's exit. Currently there are a number of EAS systems such the radio frequency (hereinafter referred to as RF), electromagnetic (hereinafter referred to as EM), and acousto-magnetic (hereinafter referred to as AM) systems. Each of the aforementioned systems have their pros and cons for any given type of vendor as each systems employs unique types of tags that have different behavioral characteristics and traits. Some tags can only be used once, as is the case with an RF tag. To be deactivated by the checkout clerk an RF tag's radio signal emitting diode is burned out by a much stronger radio signal. As an RF tag cannot be reused it is not ideal for purchases that may be returned, especially for an item whose EAS system is placed inside the item's packaging by the manufacturer. An EM tag on the other hand may be deactivated and re-activated to be re-used at will. Library books typically use EM tags for this very reason. EM tags must be deactivated or reactivated by a specific strong magnetic field within close proximity, meaning that it cannot be targeted from afar. Meanwhile an AM tag can be detected within a surveillance area by a transmitter broadcast radio frequency signal. Unfortunately, as is the case with EM tags, the AM tag must likewise be deactivated by magnetic field within close proximity. However, the biggest drawback with the RF, EM and AM tags is that none of them actually store any information about the item. The RF, EM and AM tags each act like an on and off switch at best, and one that must be switched at close proximity and in the case of the RF tag, it can only be switched off once.

The UPC barcode is ubiquitous in today's marketplace but it too has its limitations. The UPC barcode, a machine readable code of parallel bars of varying widths that store binary code, has been very successfully used to date as what can be considered to be the fingerprints of an item. Unfortunately the UPC barcode is a line of sight read only technology that can only identify the manufacturer of the item and a series or type item, not the unique item itself. Another technology that was created around the same time as the UPC barcode in the 1970s is now becoming increasingly popular because of innovation and decreasing technology costs. An RFID tag functions very similarly to the UPC barcode in that it too can identify a manufacturer and the item's series or type. However that is where the similarities between the two end. An RFID can in its most basic incarnation, store up to several kilobytes of data in its microchip which waits to be read. The RFID tag's antenna receives electromagnetic energy from the RFID reader's antenna. The RFID tag can use its own power or power captured from the RFID reader's antenna to send radio waves back to the RFID reader. The RFID reader interprets the RFID tag's radio waves as meaningful information. There is even a specific type of RFID tag, known as a “read-write” type tag. A read-write RFID tag's data may be added to or overwritten. In short, the RFID tag is a smart tag that can not only divulge information as a machine readable code but also transmit and receive information from an RFID reader. The RFID reader itself can automatically execute multiple scans simultaneously at a distance whereas a UPC barcode reader can only read one barcode per manual line of sight scan. Whereas the UPC barcode can only identify a series or type of item, like a certain style of shirt from a certain manufacturer, an RFID can be tagged with lots more information unique to the item, which for a shirt may include not only a serial number but washing and care instructions as well.

Alternative embodiment: A machine readable code, symbol or tag, like an RFID tag, that can be scanned by a handheld device, like a cellphone with a camera, or another type of portable device initiates the process of deactivating the item's security device, tag and/or system. An RFID tag may work in conjunction with or a combination of RF, EM and AM tags. When an item's RFID tag is scanned and successfully purchased, by transferring funds for payment from the user's PEP account to the vendor, the store's inventory management/tracking system acknowledges payment for the item whose RFID tag was scanned and re-categorizes the item from their inventory category to the sold category. When a scanned item is registered as a sold by the store's inventory management/tracking system the item's RFID tag is targeted by the store, via their RFID reader, and immediately deactivated. The item's security device, tag and/or system may be deactivated by the store's inventory management/tracking system itself or a separate configuration of security system or systems, such as a self-checkout station, where the purchased item's remaining EAS system(s) are deactivated. It is likely that there may be overlap in EAS technologies as RFID technology grows to be accepted as the industry standard in the marketplace. A disabled RFID or one that registers as sold would enable the self-checkout counter and allow the shopper to disable whatever EAS systems are still activate. This may be necessary as EAS systems such as those included in the packaging during the manufacturing process may be present and may not be read-write systems. There may also be certain EAS systems in place that aren't even sensors, such as tags that need to be detached like reusable hard plastic tags and benefit denial tags that that contain ink and break when tampered with. As the purchase transaction and the deactivation process of the item's security device, tag and/or systems have been successful the item is free to leave the store premises immediately without triggering any security sensors, such as the RFID reader, or other alarms.

### Re-Ordering Items

Regardless of whether the user shops online or in-store, the user can log in to their PEP profile to view their purchase history and simply click on an item they've previously purchased and would like to re-order. The PEP profile tracks the user's purchase history in order to facilitate the re-ordering process (as shown at 470 in FIG. 16). The user may order multiple quantities directly from the purchase history page and the cost of the multiple units will be shown immediately to the user (as shown at 520 in FIG. 16). When a user re-orders an item, the item is ordered and shipped from the original vendor they bought the item from. If the original vendor is not available, another vendor that sells the exact same item will be suggested. If no such item exists a vendor or vendors selling the next most similar item will be suggested. Purchase order details will be presented to the user before the purchase order transaction is initiated. This is easier for the user than having to re-visit and click through a company's catalog and/or searching for the item again. Alternative embodiment: The user may tag/categorize different items in their PEP purchase history into any number of groups. The user may wish to group together items they frequently order, or items that are used for a similar purpose, such as computer supplies. For example, if the user groups together, printer toner, printer paper, and screen cleaner under a group category name “Computer stuff,” this adds another method by which the user may more easily find and re-order the items they want.

1. A method for interactively collaborating within an online community, comprising:
a plurality of members, each member having a member profile, whereby the member profile is associated with an account;
a plurality of networks, each network having a network profile, whereby the network profile is associated with an online catalog;
whereby a member selects an item in an online catalog for purchase, whereby an amount is automatically subtracted from the balance of the account in consideration for the item.

2. The method of claim 1, whereby the item is selected by clicking the item in the online catalog.

3. The method of claim 1, whereby the item is selected by clicking on a link or icon in the online catalog.

4. The method of claim 1, whereby the member confirms the purchase prior to the amount being subtracted from the balance of the account in consideration for the item.
